(19) United States
(12) Patent Application Publication
(10) Pub. No.: US 2014/0173330 A1
(43) Pub. Date: Jun. 19, 2014

(54) Split Brain Detection and Recovery System

(71) Applicant: LSI CORPORATION, Milpitas, NE (US)

(72) Inventors: Sumanesh Samanta, Bangalore (IN); Luca Bert, Cumming, GA (US); Sujan Biswas, Bangalore (IN)

(73) Assignee: LSI CORPORATION, Milpitas, NE (US)

(21) Appl. No.: 13/715,107

(22) Filed: Dec. 14, 2012

(51) Int. Cl. G06F 11/07

(52) U.S. Cl. 714/4.11; 714/2

(57) ABSTRACT

The invention provides for split brain detection and recovery in a DAS cluster data storage system through a secondary network interconnection, such as a SAS link, directly between the DAS controllers. In the event of a communication failure detected on the secondary network, the DAS controllers initiate communications over the primary network, such as an Ethernet used for clustering and failover operations, to diagnose the nature of the failure, which may include a crash of a data storage node or loss of a secondary network link. Once the nature of the failure has been determined, the DAS controllers continue to serve all I/O from the surviving nodes to honor high availability. When the failure has been remedied, the DAS controllers restore any local cache memory that has become stale and return to regular I/O operations.

### TECHNICAL FIELD

The present invention relates to computer data storage systems networks and, more particularly, to a method and system for split brain detection and recovery in storage cluster environments having multiple DAS controllers with a single, direct interconnect link between controllers.

### BACKGROUND

High Availability among servers is required for many enterprise applications, such as live migration, fault tolerance, and distributed resource scheduling. Many clustering software environments, such as Microsoft cluster services, also depend on high availability among data storage servers.

The traditional way to achieve high availability among data storage servers is to connect the servers to storage area networks (SANs). SANs provide sharing of storage volumes among servers but are typically expensive. SANs are also I/O limited, have high latency and can turn into bottlenecks for performance hungry applications. In order to mitigate these issues, customers often resort to investing a sizable portion of their information technology budget on expensive hardware and software to support high availability functions, such as live migration or Microsoft cluster services.

Data storage clusters containing multiple directly attached storage (DAS) nodes, each with a data storage server and a DAS controller supporting multiple attached drives, can provide a high availability solution without the expense of a SAN. Multiple node DAS data storage cluster environments are therefore gaining popularity. However, these multiple server DAS cluster environments can experience failures, known as “split brain” situations, when both nodes are alive, but have no way to communicate with each other, since the link is broken. Thus the nodes cannot be sure if the Peer node is actually alive or dead.

Due to DAS controller size, power and cost considerations, many DAS cluster environments have limited hardware interconnect ports and may rely on a single interconnect link (e.g., SAS, PCIe, Ethernet or similar) to interconnect the nodes. As a result, multiple server cluster environments can experience severe problems in detecting and responding to split brain situations that occur when one of the links between server nodes fails. There is, therefore, a continuing need for methods and systems for improving the availability of storage devices in software cluster environments. More particularly, there is a need for methods and systems for detecting and responding to split brain situations in multiple node DAS cluster environments.

### SUMMARY

The needs described above are met in a split brain detection and recovery system for a multiple node DAS cluster data storage system that utilizes a secondary network interconnection, such as a SAS link, directly between the DAS controllers. In the event of a communication failure detected on the secondary network, the DAS controllers initiate communications over the primary network, such as an Ethernet used for clustering and failover operations, to diagnose the nature of the failure, which may include a crash of a data storage node or loss of a secondary network link. Once the nature of the failure has been determined, the DAS controllers continue to serve all I/O from the surviving nodes to honor high availability. When the failure has been remedied, the DAS controllers restore any local cache memory that has become stale and return to regular I/O operations.

In a multiple node DAS data storage cluster, each node typically includes an upper layer server connected to a DAS controller, which in turn supports multiple attached data storage devices. The servers are connected to each other through a primary network, such as an Ethernet, over which clustering, failover, RAID and other data storage protocols may be implemented utilizing the attached data storage devices in the various storage nodes. The invention provides for split brain detection and recovery through a secondary network interconnection, such as a SAS link, directly between the DAS controllers. In the event of a communication failure detected on the secondary network, the DAS controllers initiate communications over the primary network to diagnose the nature of the failure, which may include a crash of a data storage node or loss of a secondary network link.

Once the nature of the failure has been determined, the DAS controllers continue to serve all I/O from one or more surviving nodes to honor high availability. When the failure has been remedied, the DAS controllers restore any local cache memory utilized by DAS controllers that has become stale and return to regular I/O operations. As the primary network (e.g., Ethernet) is used for inter-controller communications only when a communication failure is detected on the secondary network (e.g., SAS), regular I/O served over the primary network is not dependent on the secondary network link and does not suffer any performance impact in the absence of a failure condition in the DAS system.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

The numerous advantages of the invention may be better understood with reference to the accompanying figures in which:

FIG. 1 is a block diagram of a two node DAS cluster data storage topology including a split brain detection and recovery system.

FIG. 2 is a block diagram of illustrating the operation of the split brain detection and recovery system.

FIG. 3 is a logic flow diagram illustrating provisioning of the split brain detection and recovery system.

FIG. 4 is a logic flow diagram illustrating I/O processing in the split brain detection and recovery system.

FIG. 5 is a logic flow diagram illustrating a leader communication failure mode in the split brain detection and recovery system.

### DETAILED DESCRIPTION OF ILLUSTRATIVE EMBODIMENTS

The invention may be embodied in a multiple node DAS cluster data storage system having separate upper layer servers that are each connected to a separate DAS controller that supports multiple attached data storage devices. It should be understood that this invention applies equally to high availability systems with either implemented as virtual machines or through clustering software without virtual machines. While the diagrams described below show a virtual machine embodiment, the invention it is equally applicable for embodiments using clustering software, such as Windows Cluster.

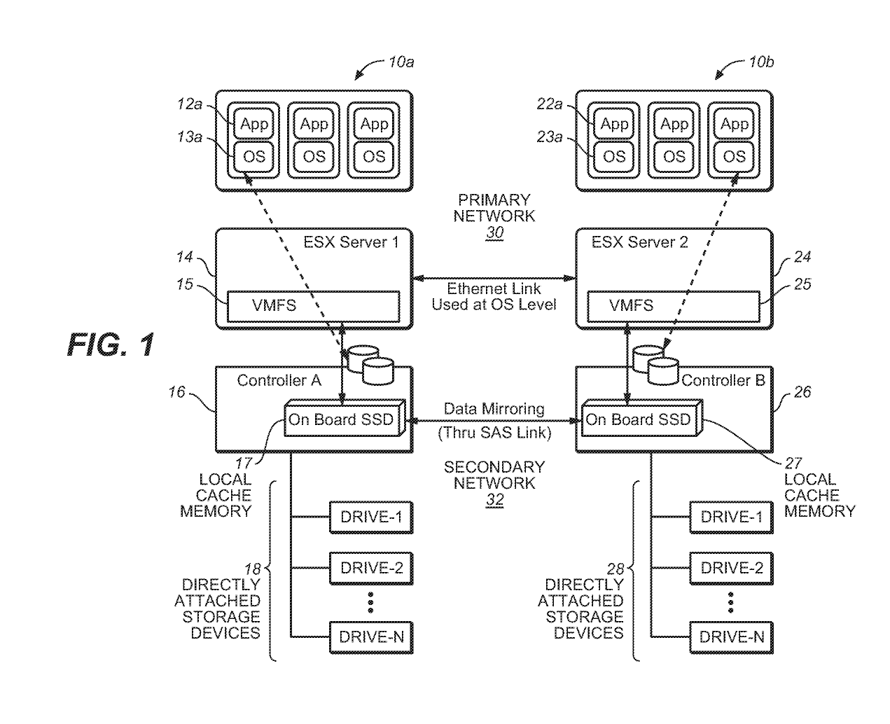

To illustrate one simple virtual machine embodiment illustrating the operating principles of the invention, FIG. 1 is a block diagram of a simple two node data storage system including a split brain detection and recovery system. Although the cluster may include any number of nodes, FIG. 1 shows a simplified two-node cluster suitable for illustrating the operating principles of the invention. The Illustrative nodes 10a and 10b of the cluster may be referred to as “local and remote” or “leader and peer” for descriptive convenience.

For this example, the first node 10a of the storage cluster includes an application 12a and associated operating system (OA) service 13a running on a server 14, such as an ESX server. The server 14, which typically supports many applications and associated OS application services, includes a virtual machine file system 15 that coordinates data storage operations with a directly attached storage (DAS) controller 16. The DAS controller 16 includes a local high speed cache memory 17, in this example an onboard solid state device (SSD) chip. The DAS controller 16 also supports a number of directly attached storage devices 18, typically hard drives.

The second node 10b of the cluster may be similarly configured. In this example, the second node 10b of the storage cluster includes an application 22a and associated operating system (OA) service 23a running on a server 24, such as an ESX server. The server 24 includes a virtual machine file system 25 that coordinates data storage operations with a directly attached storage (DAS) controller 26. The DAS controller 26 includes a local high speed cache memory 27, again in this example an onboard solid state device (SSD) chip. The DAS controller 27 also supports a number of directly attached storage devices 28, typically hard drives.

The local cache memory 17 can be accessed by its local DAS controller 16, but cannot be directly accessed by the remote DAS controller 26, just like the other local disks 18 that are directly attached to the DAS controller 16. Similarly, the local cache memory 27 can be accessed by its local DAS controller 26, but cannot be directly accessed by the remote DAS controller 17, just like the other local disks 28 that are directly attached to the DAS controller 26. Although the local cache memory 17, 27 is distributed among the DAS controllers 16, 26, the combined cache is exposed to the upper layer servers 14, 24 as a single memory resource integrated with the attached storage devices 18, 28. The split brain problem occurs when coordination is interrupted among the cache memories 17, 27 running on the DAS controllers 16, 26.

The servers 14, 24 are connected to each other through a primary network 30, such as an Ethernet, over which clustering, failover, RAID and other data storage protocols may be implemented utilizing the attached data storage devices 18, 28 in the storage nodes in a coordinated manner. The invention provides for split brain detection and recovery through a secondary network interconnection 32, such as a SAS link, directly between the DAS controllers 16, 26. In the event of a communication failure detected on the secondary network 32, the DAS controllers 16, 26 initiate communications over the primary network 30 to diagnose the nature of the failure, which may include a crash of one of the data storage controllers 16, 26, or loss of the secondary network link 32. Once the nature of the failure has been determined, the DAS controllers 16, 26 continue to serve all I/O from the surviving node (or nodes) to honor high availability. When the failure has been remedied, the DAS controllers 16, 26 restore any local cache memory that has become stale and return to regular I/O operations. As the primary network 30 (e.g., Ethernet) is used for inter-controller communications only when a communication failure is detected on the secondary network 32 (e.g., SAS), regular I/O served over the primary network 30 is not dependent on the secondary network link 32 and does not suffer any performance impact in the absence of a failure condition in the DAS system.

The DAS controllers 16, 26 mirror local storage (typically “dirty write” data) in the cache memories 17, 27 and provide I/O back-up among themselves while appearing to the upper layer of the operating system (OS) and the servers 14, 24 as a single, seamless storage volume integrated with the directly attached drives 18, 28. This allows the multiple DAS controllers 16, 26 to effectively emulate a SAN disk to the upper layers of the OS and consequently to the servers 14, 24.

To maintain internal data integrity, the DAS controllers 16, 26 mirror “write” data stored in the local cache memories 17, 27 with each other. The “write” data stored in local cache is sometimes referred to as “dirty write” data because it typically contains data recently received from or altered by user input that has not yet been transferred to permanent storage in the attached storage devices 18, 28. The “dirty write” data is maintained in cache memory to speed access to the data while the data subject to frequent user access (“hot” data). Mirroring the write data in both cache memories 17, 27 allows that the same data to be accessed from either local cache memory at any time while the “hot” data is maintained in cache and prior to transferring the data to permanent storage in the attached storage devices 18, 28.

It should be understood that while the DAS controllers 16, 26 talk to each other over the dedicated SAS link 32, the upper level OS software running on the servers 14, 24, such as ESX servers, continue to use the separate, primary network 30, such as an Ethernet, for clustering, failover, RAID and other data storage operations. It should also be appreciated that while onboard SSD drives 17, 27 provide one mechanism for local cache storage, the invention equally applies to cases where the local cache memory is provided on any other type of storage device, such as a local drive connected to the server (not necessarily on board) or even to cases where the servers have shared disks. Regardless of the type of local cache storage employed in any particular topology, the invention provides a solution for detection of split brain occurrences, for example when the secondary interconnect link 32 between the DAS controllers 16, 26 fails, even when there is no direct hardware based solution available.

For split brain detection, the DAS controllers 16, 26 use the secondary interconnect link 32 to exchange data for mirroring and control information. The secondary interconnect 32 may be a SAS link, PCIe, Ethernet or any other interconnect that allows data exchange between the DAS controllers 16, 26. In a typically DAS environment, the number of ports available for inter-controller connection is severely limited and, in many cases, only a single port may be available. That is because of the limited real estate on the small form factor DAS controllers, power issues that limit usage of onboard expanders, or simply because other ports are being used to connect to local or onboard disks.

When two DAS controllers are directly connected by only a single interconnect link, they may use that link to for data mirroring and also to send “heartbeat” connectivity information to each other. The split-brain problem occurs when one of the DAS controllers 16, 26 does not receive the expected “heartbeat” connectivity signal from the other node and has no other mechanism available to contact the other node. A communication failure between the DAS nodes 16, 26 can be because of two reasons, either one of the DAS controllers has crashed or the secondary interconnect link 32 between the controllers has been interrupted. These two situations require different responses. When the remote DAS controller has crashed for some reason, to honor high availability the surviving node takes over all shared resources and start serving all I/O, so that the upper OS layer cluster software and clustered applications can continue to run smoothly. On the other hand, when both nodes are alive but the secondary interconnect link between the controllers has been interrupted (the “split brain” situation), data stored in the local cache memories 17, 27 can no longer be mirrored.

To provide a solution to the “split brain” situation, a tiebreaker is utilized to designate a selected DAS controller to begin serving all I/O, while the other controller fails all I/O. As one example for implementing the tiebreaker, one of the DAS controllers in any given topology may be designated as the “leader” for each virtual drive (VD) at start-up using any suitable any arbitration mechanism. For example, starting with lower SAS address, Server-1 may be designated as the leader for VD-0, Server-2 may be designated as the leader for VD-1, and so forth with toggling between the servers for additional virtual drives. As another example, if “Persistent Reservation” based distinction can be made, then the server that received the most recent Persistent Reservation for a particular virtual drive may be designated as the leader for that drive. As yet another example, the active server may always be designated at the leader for an active-passive cluster setup.

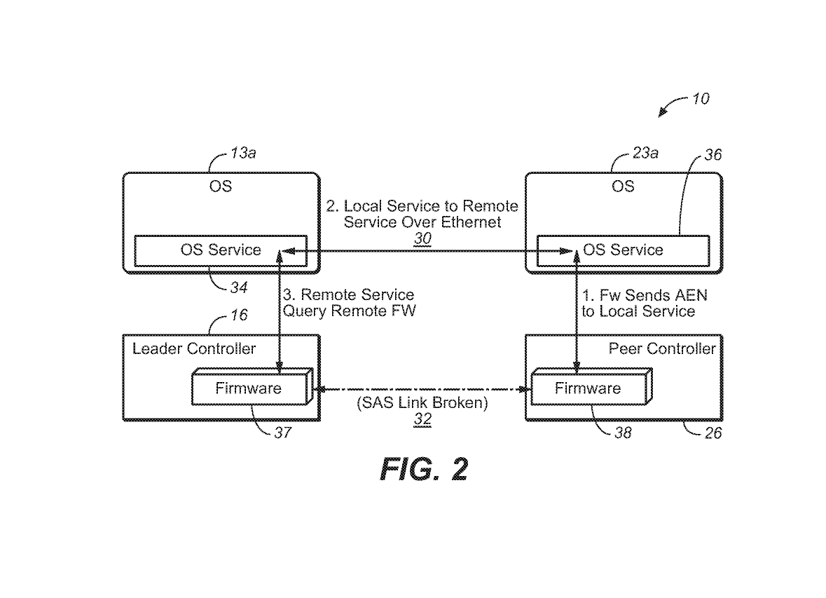

FIG. 2 is a block diagram of illustrating the operation of the split brain detection and recovery system. In this particular illustrative embodiment, split brain detection may be implemented through an available OS service 34, 36 available through the operating systems 13a, 23a running on the host servers 14, 24. For this example, the DAS controller 16 is designated as the leader node and the DAS controller 26 is designated as the peer. The split brain detection and recovery logic varies depending on whether the leader node 16 or the peer node 26 has detected the failure. When the leader node 16 detects a communication failure with the peer node 26, the leader node 16 begins to serve all I/O, regardless of whether the communication failure was caused by loss of the peer node 26 or the interconnect link 32, until communications with the peer node 26 has been restored and the local cache memory 27 on the peer node 26 has been rebuilt. The leader node 16 also takes over any resources shared with the peer node 16 and may implement additional actions to facilitate restoration when the communication failure is resolved, such as creating a “write log” to facilitate restoration of the peer node cache memory 27 when communications with the peer node 26 are restored.

When the peer node 26 detects that it has lost communication with the leader 16, on the other hand, the procedure is more complex because the peer DAS controller 26 should overtake I/O only when the leader controller 16 has failed. That is, the peer node 26 should allow the leader node 16 to serve all I/O if the leader node is alive. As a result, the peer node 26 should serve all I/O itself only when the leader node 16 is confirmed to be dead. When the leader DAS controller 16 is alive, and the communication interruption is caused by a failure of the secondary interconnect link 32, the peer node 26 should fail all I/O.

To implement this functionality through an available OS service 34, 36, the moment that a peer node 26 detects a communication failure with the leader node 16, it temporarily holds all I/O and sends an asynchronous message to its local OS application service 36 (i.e., the OS application service running on the peer server 24) requesting it to ping the leader server 14 over the primary network 30 (e.g., Ethernet). If the peer controller 26 does not receive a response from its OS application service 36, the peer node 26 begins to fail all I/O to be on the safe side (i.e., to avoid potential “write” data corruption in the event that the leader node 16 is alive and serving the I/O but unable to communicate with the peer node because the secondary network link 32 is down).

Alternatively, if the peer node 26 receives a response indicating that the peer OS application service 36 could not contact the leader OS application service 34 over the primary network 30, then the peer node 26 confirms that the leader node 16 is dead and begins serving all I/O. However, if the peer OS application does receive a response from the leader OS application service 34, then further investigation is required to determine the status of the leader DAS controller 16. Specifically, in response to the message received from the peer OS application service 36, the leader OS application service 34 pings the DAS firmware 37 running on the leader DAS controller 16 to determine whether the leader node 16 is alive or dead. The result of this ping is communicated to the peer OS application service 36, which provides a “leader alive” or a “leader dead” message to the peer DAS firmware 38 running on the peer node 26.

If the peer DAS firmware 38 receives a “leader alive” message, the peer node 26 fails all I/O. As the peer side cache data then becomes stale, the peer node does not resume serving any I/O until a “rebuild” operation has been performed for the peer local cache memory 27. Alternatively, if the peer DAS firmware 38 receives a “leader dead” message, the peer node 26 begins to server all I/O, takes over any resources shared with the leader node 16, and may take additional steps to facilitate rebuilding of the leader cache memory 17, such as maintaining a “write log” while the leader node is down. As the leader side cache data then becomes stale, the leader node 16 does not resume serving any I/O until a “rebuild” operation has been performed for the leader local cache memory 17.

This procedure can be readily expanded to cover any number DAS controller nodes, and any number of virtual drives, by dedicating one of the nodes to serve as the leader for each virtual disk. Only a single secondary network link is required to each DAS controller (SAS link or otherwise) to effectively detect and deal with the split brain scenario. It should also be noted that the primary network (e.g., Ethernet) is used for inter-controller communications only when a communication failure is detected on the secondary network (e.g., SAS), which can occur when DAS controller crashes or a secondary network link snaps. For regular I/O served over the primary network, there is no dependency on the secondary network link, and hence no performance impact.

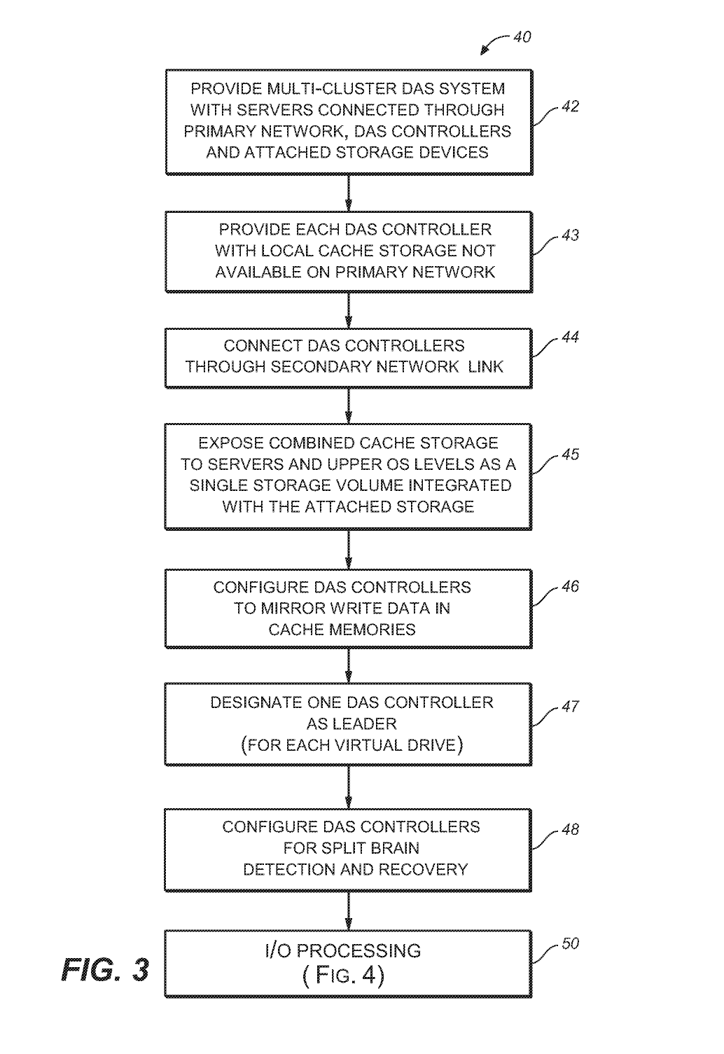

FIG. 3 is a logic flow diagram illustrating a routine 40 for provisioning the split brain detection and recovery system. In step 42, a multi-cluster DAS system is provided with servers connected through a primary network, such as an Ethernet. Each server is further provided with an associated DAS controller with attached data storage devices. Step 42 is followed by step 43, in which each DAS controller is provided with a local cache memory not available to the other controllers over the primary network. Step 43 is followed by step 44, in which the DAS controllers are directly connected to each other via a secondary network, such as SAS links.

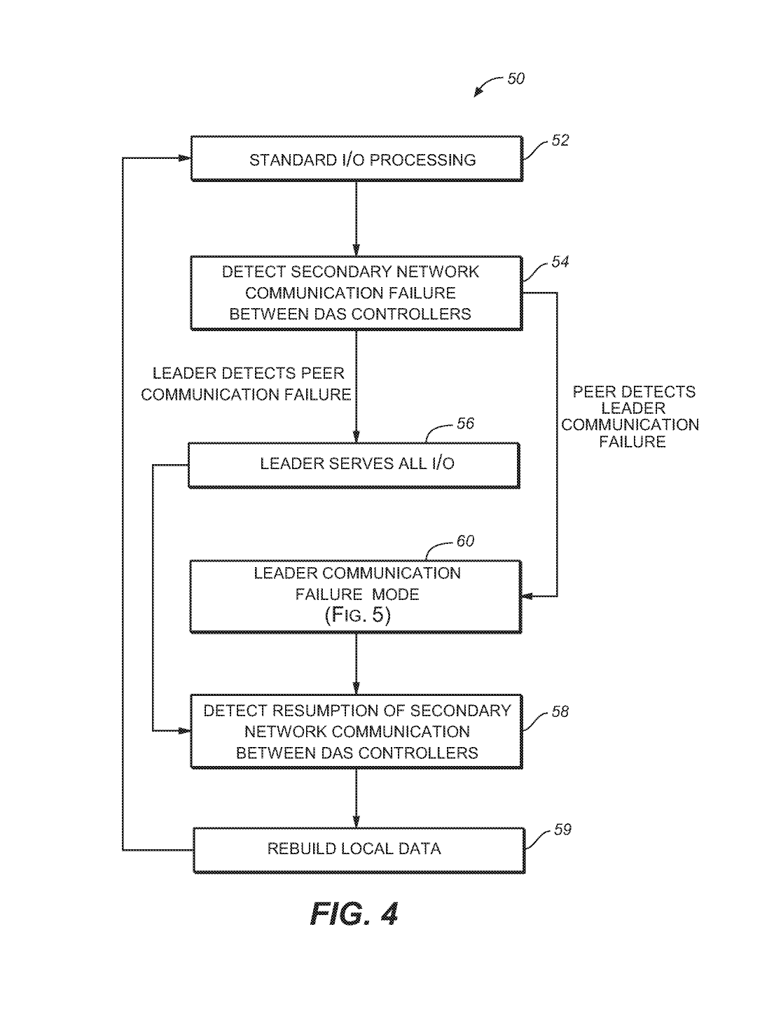

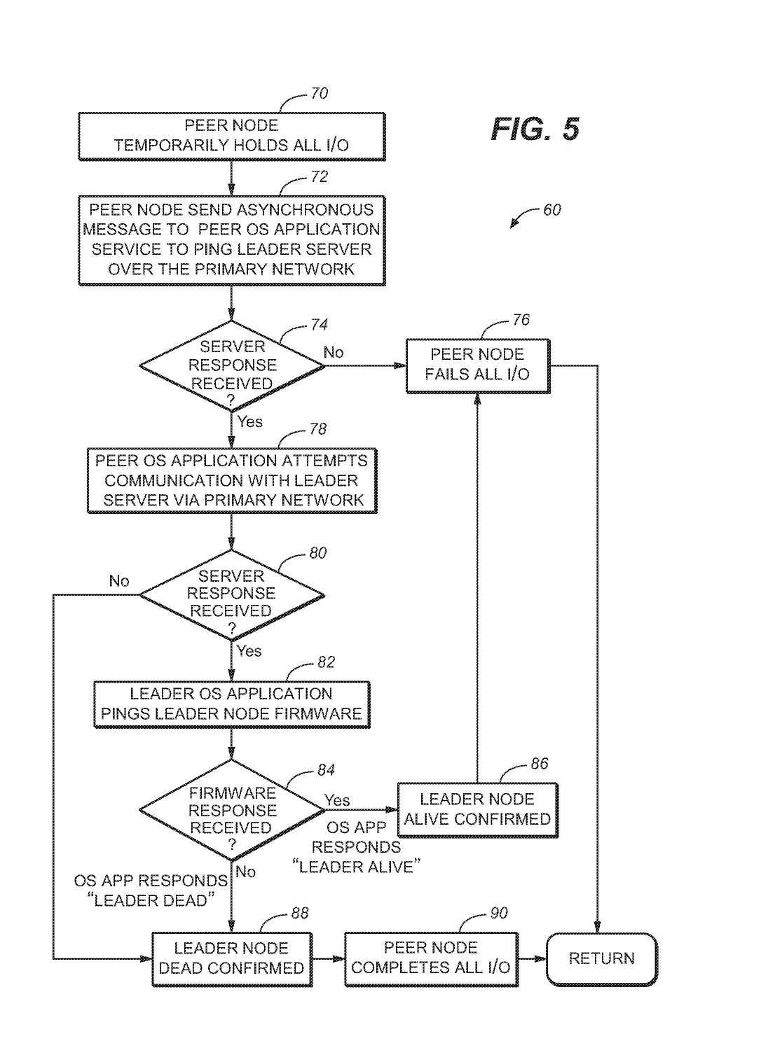

Step 44 is followed by step 45, in which the DAS controllers expose the combined cache memory to the servers and upper OS levels as a single storage volume integrated with the attached storage devices. Step 45 is followed by step 46, in which the DAS controllers are configured to mirror write data stored in the cache memories. Step 46 is followed by step 47, in which one of the DAS controller is designated as the leader node. If the multiple virtual drives are defined, then a leader node is designated for each virtual drive. Step 47 is followed by step 48, in which the DAS controllers are configured to implement split brain detection and recovery, as described in more detail with reference to FIGS. 4 and 5. The DAS system is now provisioned for split brain detection and recovery, and I/O processing begins in step 50, which is expanded and described further with reference to FIG. 4.

FIG. 4 is a logic flow diagram expanding step 50 for I/O processing in the split brain detection and recovery system. In step 52, the DAS controllers implement standard I/O processing, which included mirroring of “write” data in the cache memories and serving I/O requests for “hot” data stored in the cache memory from the local cache for a requesting server. Step 52 is followed by step 54, in which one of the DAS controllers detects a secondary network communication failure with another node, which may be caused by failure of the other node or loss of the secondary network link with the other node. If the leader node has detected a communication failure with a peer node, the step 54 is followed by step 56, in which the leader node serves all I/O until communications have been restored with the peer node. Step 56 is then followed by step 58, in which the resumption of secondary network communications is detected, in this case of peer node failure the leader node detects resumption of communications with the peer node over the secondary network. Step 58 is then followed by step 59, in which the stale local cache memory is rebuilt. Again in this case of peer node, it is the peer local cache memory that required restoration.

On the other hand, if it is the peer node that detects a loss of communication with the leader node, step 54 is followed by step 60, which is a leader communication failure mode illustrated in greater detail on FIG. 5. Once the failure has been resolved, step 60 is then followed by step 58, in which the resumption of secondary network communications is detected, in this case of leader node failure the peer node detects resumption of communications with the leader node over the secondary network. Step 58 is then followed by step 59, in which the stale local cache memory is rebuilt. Depending on whether the source of the communication failure was loss of the secondary network link or loss of the leader node, the local cache memory that requires restoration is rebuilt. Specifically, when the leader node crashed, it is the leader cache memory that requires restoration, and when the secondary network link dropped, it is the peer cache memory that requires restoration.

FIG. 5 is a logic flow diagram expanding the leader communication failure mode 60. In step 70, the peer note temporarily holds all I/O. Step 70 is followed by step 72, in which the peer node sends an asynchronous message to the peer OS application service asking the peer OS application service to ping the leader server over the primary network. Step 72 is followed by step 74, is which the peer node waits for a ping response and determines whether it has received a ping response. If the peer node does not receive a ping response, the “No” branch is followed to step 76, in which the peer node fails all I/O and the procedure returns to step 58 shown in FIG. 4, in which the DAS system waits for and ultimately detects restoration of the secondary communication link with the leader node.

Alternatively, if the peer node does receive a ping response, the “Yes” branch is followed from step 74 to step 78, in which the peer OS application service attempts to communicate with the leader server over the primary network. Step 78 is followed by step 80, in which the peer OS service determines whether leader OS service has responded. If the peer OS service does not receive a response form the leader OS service, the “NO” branch is followed to step 88, in which the leader node is confirmed dead. Step 88 is ten followed by step 90, in which the peer node serves all I/O, takes over any shared resources, and typically begins a write log to facilitate restoration of the leader cache memory. The procedure the returns to step 58 shown in FIG. 4, in which the DAS system waits for and ultimately detects restoration of communications with the leader node.

If the peer OS service does receive a response from the leader OS service in step 80, the “Yes” branch is followed to step 82, in which the leader OS service pings the leader node DAS firmware to confirm availability of the leader node. If the leader node OS service receives a ping response form the DAS firmware, the “Yes” branch is followed to 86, in which the leader OS application service sends a “leader alive” response to the peer OS application service and the leader node is confirmed alive. Step 86 is then followed by step 76, in which the peer node fails all I/O and the procedure returns to step 58 shown in FIG. 4, in which the DAS system waits for and ultimately detects restoration of the secondary communication link with the leader node.

If the leader DAS firmware does not provide a ping response, the “No” branch is followed from step 84 to step 88, in which the leader OS application service sends a “leader dead” response to the peer OS application service and the leader node is confirmed dead. Step 88 is then followed by step 90, in which the peer node serves all I/O, takes over any shared resources, and typically begins a write log to facilitate restoration of the leader cache memory. The procedure the returns to step 58 shown in FIG. 4, in which the DAS system waits for and ultimately detects restoration of communications with the leader node.

The present invention may consist (but not required to consist) of adapting or reconfiguring presently existing systems. Alternatively, original equipment may be provided embodying the invention.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

It is further contemplated that each of the embodiments of the method described above may include any other step(s) of any other method(s) described herein. In addition, each of the embodiments of the method described above may be performed by any of the systems described herein.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Furthermore, it is to be understood that the invention is defined by the appended claims.

Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The invention claimed is:

1. A directly attached storage (DAS) computer data storage system including a split brain detection and recovery system, comprising:
a first data storage node comprising a first server having a first operating system application service and a first virtual machine file system running on the first server, a first DAS controller operatively connected to the first server, a first set of directly attached data storage devices connected to the first DAS controller, and a first local cache memory dedicated to the first data storage node;
a second data storage node comprising a second server having a second operating system application service and a second virtual machine file system running on the first server, a second DAS controller operatively connected to the second server, a second set of directly attached data storage devices connected to the second DAS controller, and a second local cache memory dedicated to the second data storage node;
a primary network connection directly between the first and second servers;
wherein the first virtual machine file system is configured with direct access to the first set of data storage devices and the first local cache memory but is not configured with direct access to the second set of data storage devices or the second local cache memory;
wherein the second virtual machine file system is configured with direct access to the second set of data storage devices and the second local cache memory but is not configured with direct access to the first set of data storage devices or the first local cache memory;
wherein during regular I/O operations the first and second DAC controllers coordinate data storage access over the primary network to expose an integrated data storage volume to the first and second virtual machine file system comprising the first and second sets of directly attached data storage devices and the first and second local cache memories;
a secondary network connection directly between the first and second DAS controllers used by the DAS controllers to mirror data stored in the local cache memories and exchange connectivity information;
wherein the first and second DAS controllers are configured to detect a split brain situation comprising a loss of connectivity between the DAS controllers over the secondary network connection and to implement corrective actions in response to the split brain situation to main access to and integrity of data stored in the local cache memories.

2. The DAS computer data storage system of claim 1, wherein the first and second DAS controllers are configured to discriminate between a loss of connectivity caused by failure of one of the DAS controllers and a loss of connectivity caused by failure of the secondary network connection and vary the corrective action based on the cause of the loss of connectivity.

3. The DAS computer data storage system of claim 2, wherein:
the first and second DAC controllers are configured to designate the first DAS controller as a leader controller and the second DAS controller as a peer controller; and
upon detection of a first split brain occurrence caused by failure of the peer controller or failure of the secondary network connection, the leader controller is configured to serve all I/O until resolution of the first split brain occurrence.

4. The DAS computer data storage system of claim 3 wherein, upon detection of the first split brain occurrence, the leader controller is further configured to:
maintain a write log during the first split brain occurrence;
detect a resolution of the first split brain occurrence;
provide the peer controller with access to the write log to restore the local cache memory of the peer controller; and
resume regular I/O processing upon restoration of the local cache memory of the peer controller.

5. The DAS computer data storage system of claim 4 wherein, upon detection of a second split brain occurrence, the peer controller is configured to determine whether the second split brain occurrence is caused by failure of the leader controller or failure of the secondary network connection.

6. The DAS computer data storage system of claim 5, wherein the peer controller is configured to fail all I/O upon determining that second split brain occurrence is caused by failure of the secondary network connection.

7. The DAS computer data storage system of claim 6 wherein, upon determining that second split brain occurrence is caused by failure of the secondary network connection, the peer controller is further configured to:
detect a resolution of the second split brain occurrence;
access a write log maintained by the leader controller during the second split brain occurrence;
restore the local cache memory of the peer controller from the write log; and
resume regular I/O processing upon restoration of the local cache memory of the peer controller.

7. The DAS computer data storage system of claim 8, wherein the peer controller is configured to serve all I/O upon determining that second split brain occurrence is caused by failure of the leader controller.

8. The DAS computer data storage system of claim 9 wherein, upon determining that the second split brain occurrence is caused by failure of the leader controller, the peer controller is further configured to:
maintain a write log during the second split brain occurrence;
detect a resolution of the second split brain occurrence;
provide the leader controller with access to the write log to restore the local cache memory of the leader controller; and
resume regular I/O processing upon restoration of the local cache memory of the leader controller;

10. The DAS computer data storage system of claim 9, wherein the DAS controllers are further operative to utilize the primary network connection to implement the corrective actions.

11. The DAS computer data storage system of claim 10, wherein the DAS controllers are further operative to utilize the operating system application services running on the first an second servers to implement the corrective actions.

12. The DAS computer data storage system of claim 11, wherein the first DAS controller is further configured to prompt the first operating system application service to ping the second operating system application service over the primary network connection.

13. The DAS computer data storage system of claim 12, wherein the first DAS controller is further configured to prompt the second operating system application service to ping firmware running on the second DAS controller.

14. A split brain detection and recovery system in or for a directly attached storage (DAS) computer data storage system including first and second servers interconnected by a primary network connection, comprising:
a secondary network connection directly between first and second DAS controllers used by the DAS controllers to mirror data stored in local cache memories and exchange connectivity information; and
wherein the DAS controllers are configured to detect a split brain situation comprising a loss of connectivity between the DAS controllers over the secondary network connection and to implement corrective actions in response to the split brain situation to main access to and integrity of data stored in the local cache memories.

15. The split brain detection and recovery system of claim 14, wherein the DAS controllers are further operative to utilize the primary network connection to implement the corrective actions.

16. The split brain detection and recovery system of claim 15, wherein the DAS controllers are further operative to utilize operating system application services running on the first and second servers to implement the corrective actions.

17. The split brain detection and recovery system of claim 14, wherein the corrective actions comprise serving I/O from a surviving DAS controller, maintaining a write log during the split brain situation, detecting resolution of the split brain situation, restoring the local cache memory of a failed DAS controller, and resuming regular I/O processing.

18. A method for split brain detection and restoration in a DAS computer storage system comprising a primary network connection, comprising the steps of:
providing a secondary network connection between first and second DAS controllers;
detecting a split brain situation comprising a loss of connectivity between the DAS controllers over the secondary network connection;
utilizing the primary network to determine a cause of the split brain situation;
serving all I/O from a surviving DAS controller during the split brain situation;
maintaining a write log during the split brain situation;
detecting a resolution of the cause of the determined cause of the split brain situation;
using the write log to restore a local cache memory of a failed DAS controller; and
resuming regular I/O processing upon restoration of the local cache memory.

19. The method of claim 18, wherein the step of utilizing the primary network to determine a cause of the split brain situation further comprises the step utilizing operating system application services running on the first and second servers to determine a cause of the split brain situation.

20. A non-transitory computer storage medium comprising computer executable instructions for performing a method for split brain detection and restoration in a DAS computer storage system comprising a primary network connection, comprising the steps of:
detecting a split brain situation comprising a loss of connectivity between the DAS controllers over a secondary network connection;
utilizing the primary network to determine a cause of the split brain situation; and
serving all I/O from a surviving DAS controller during the split brain situation,
maintaining a write log during the split brain situation,
detecting a resolution of the cause of the determined cause of the split brain situation,
using the write log to restore a local cache memory of a failed DAS controller, and
resuming regular I/O processing upon restoration of the local cache memory.
